(19) United States
(12) Patent Application Publication
(10) Pub. No.: US 2022/0403292 A1
(43) Pub. Date: Dec. 22, 2022

(54) LAUNDRY POWDER DETERGENT COMPOSITION

(71) Applicant: Clariant International Ltd., Muttenz (CH)

(72) Inventors: Xiaoqiang Guo, Frankfurt am Main (DE); Hannah Benson, Heppenheim (DE)

(73) Assignee: Clariant International Ltd., Muttenz (CH)

(21) Appl. No.: 17/770,556

(22) PCT Filed: Oct. 21, 2020
(86) PCT No.: PCT/EP2020/079665

§ 371 Date: Apr. 20, 2022

(30) Foreign Application Priority Data
Oct. 22, 2019 (EP) 19204676.1

(51) Int. Cl. C11D 1/83; C11D 1/06; C11D 1/40; C11D 1/29; C11D 3/10; C11D 17/06

(52) U.S. Cl. CPC C11D 1/83; C11D 1/06; C11D 1/40; C11D 1/29; C11D 3/10; C11D 17/06

(57) ABSTRACT

The present invention relates to laundry powder detergent compositions comprising: Z1) one or more surfactants on magnesium carbonate carrier and Z2) one or more anionic surfactants which are not present on a carrier. These laundry powder detergent compositions may be used for cleaning of textiles which can be carried out in an automatic washing machine or as manual cleaning.

The present invention relates to laundry powder detergent compositions comprising one or more surfactants on magnesium carbonate carrier Z1) and one or more anionic surfactants which are not present on a carrier Z2), the use of the laundry powder detergent compositions of the invention for cleaning of textiles, the use of the one or more surfactants on magnesium carbonate carrier Z1) for reducing the thermal degradation of surfactants during the preparation of the laundry powder detergent compositions of the invention, the use of one or more surfactants on magnesium carbonate carrier Z1) for the preparation of the laundry powder detergent compositions of the invention and the preparation of the laundry powder detergent compositions of the invention.

Conventional laundry powder detergent compositions are typically produced via a spray drying process, in which the detergent ingredients are mixed in a concentrated viscous slurry and dried with hot gases, resulting in puffed, shell-like detergent beads. However, some surfactants are not compatible with the spray drying process temperatures, which are often significantly above 100° C., and e.g. at 250° C. Going through the whole spray drying process could induce degradation of the surfactants, and therefore introduce impurities into the final laundry powder detergent composition. Moreover, these surfactants usually are not completely solid. They can be either liquid or waxy substances at room temperature. Therefore, it is also difficult to still maintain the free-flowing property of a laundry power detergent composition by adding these surfactants directly after the spray drying process. Additionally, the surfactants added after the spray drying process may not dissolve in water, especially when low washing temperatures are used, as quickly as powders from the spray drying process. Such solubility problems are especially troublesome when the detergent contains bleaching agents, since undissolved components can be entrained or trapped on the fabrics and cause “pin-point” bleach damage to colors and to the fabric itself.

Therefore, it was the object of the present invention to provide laundry powder detergent compositions and to enable the incorporation of surfactants into the laundry powder detergent compositions by reducing the above-mentioned disadvantages, in particular by reducing degradation of surfactants used in the preparation of the laundry powder detergent compositions.

Surprisingly, it has been found that the above-mentioned object can be solved by means of laundry powder detergent compositions comprising

Z1) one or more surfactants on magnesium carbonate carrier
and
Z2) one or more anionic surfactants which are not present on a carrier.

Therefore, a subject matter of the present invention is laundry powder detergent compositions comprising

Z1) one or more surfactants on magnesium carbonate carrier
and
Z2) one or more anionic surfactants which are not present on a carrier.

Within the meaning of the present invention “laundry powder detergent compositions” in granular form also are inventive compositions, i.e. inventive laundry powder detergent compositions encompass respective compositions in granular form.

EP 3 517 502 A1 discloses a carrier material consisting of a magnesium carbonate for the release of one or more active agent(s) in a home care formulation.

U.S. Pat. No. 6,908,895 B2 discloses a laundry powder detergent comprising a granular component comprising organic surfactant and zeolite which is non-spray-dried. However, zeolites have some disadvantages. They are not biodegradable, and they are insoluble in water, thus adding solid waste to the environment.

### Component Z1)

Preferably, at least one surfactant of the one or more surfactants, and more preferably the one or more surfactants on magnesium carbonate carrier of component Z1) of the inventive laundry powder detergent compositions are selected from the group consisting of nonionic and anionic surfactants.

More preferably, at least one surfactant of the one or more surfactants, and even more preferably the one or more surfactants on magnesium carbonate carrier of component Z1) of the inventive laundry powder detergent compositions are selected from the group consisting of N-hydrocarbon-substituted N-acyl-glucamines and alkyl or alkenyl ether carboxylic acids or their salts.

Preferably, the N-hydrocarbon-substituted N-acyl-glucamines on magnesium carbonate carrier of component Z1) of the inventive laundry powder detergent compositions are selected from the formula (I)

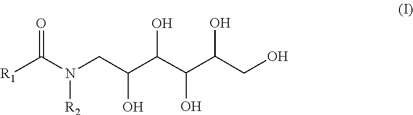

wherein
R1 is a linear or branched, preferably a linear, saturated alkyl group having 7 to 21 and preferably 7 to 17 carbon atoms, or a linear or branched, preferably a linear, unsaturated alkenyl group having one or more double bonds and 7 to 21, preferably 7 to 17, carbon atoms,
R2 is a linear or branched, preferably a linear, saturated alkyl group having 1 to 6 carbon atoms, more preferably a methyl, ethyl, propyl or butyl group and even more preferably a methyl group.

Preferably, R1CO in formula (I) is selected from the group consisting of capryloyl, pelargonoyl, caproyl, undecyloyl, lauroyl, tridecyloyl, myristoyl, pentadecyloyl, palmitoyl, margaroyl, stearoyl, myristoleoyl, pamitoleoyl, oleoyl, linolenoyl and mixtures thereof.

More preferably, R1 in formula (I) is a linear saturated alkyl group having 11 to 13 carbon atoms and R2 is a methyl group, R1CO in formula (I) derives from coconut oil and R2 is a methyl group or R1CO in formula (I) derives from sunflower oil and R2 is a methyl group.

In one even more preferred embodiment of the invention, R1 in formula (I) is a linear saturated alkyl group having 11 to 13 carbon atoms and R2 is a methyl group.

In a further even more preferred embodiment of the invention, R1CO in formula (I) derives from coconut oil and R2 is a methyl group.

In a further even more preferred embodiment of the invention, R1CO in formula (I) derives from sunflower oil and R2 is a methyl group.

Preferably, the alkyl or alkenyl ether carboxylic acids or their salts on magnesium carbonate carrier of component Z1) of the inventive laundry powder detergent compositions are selected from the formula (II)

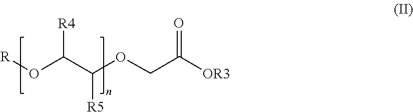

wherein
R is a linear or branched, preferably a linear, saturated alkyl group having 6 to 22 and preferably 8 to 18 carbon atoms or a linear or branched, preferably a linear, unsaturated alkenyl group having one or more double bonds and 6 to 22, preferably 8 to 18, carbon atoms,
R4 and R5 are either both hydrogen, or R4 is hydrogen and R5 is methyl, or R4 is methyl and R5 is hydrogen,
R3 is hydrogen or a cation, preferably a cation selected from the group consisting of Na⁺, K⁺ and NH₄⁺,
n is a number from 1 to 30 and preferably from 5 to 25.

The variable “n” in the one or more compounds of the formula (II) preferably represents molar averages, meaning that the laundry powder detergents of the invention may comprise a plurality of compounds of the formula (II) having different degrees of alkoxylation.

Preferably, R in formula (II) is selected from the group consisting of caprylyl, pelargonyl, capryl, undecylyl, lauryl, tridecylyl, myristyl, pentadecylyl, palmityl, margaryl, stearyl, myristoleyl, pamitoleyl, oleyl, linolenyl and mixtures thereof.

More preferably, R in formula (II) is oleyl, R4 and R5 are hydrogen and n is from 5 to 15, preferably 7 to 12 and more preferably 10 or R in formula (II) is stearyl, R4 and R5 are hydrogen and n is from 10 to 25, preferably from 15 to 23 and more preferably 20. In these embodiments of the invention R3 in formula (II) is hydrogen or a cation and preferably a cation selected from the group consisting of Na⁺, K⁺ and NH₄⁺.

In one even more preferred embodiment of the invention, R in formula (II) is oleyl, R4 and R5 are hydrogen and n is from 5 to 15, preferably from 7 to 12 and more preferably 10. In this even more preferred embodiment of the invention R3 in formula (II) is hydrogen or a cation and preferably a cation selected from the group consisting of Na⁺, K⁺ and NH₄⁺.

In a further even more preferred embodiment of the invention, R in formula (II) is stearyl, R4 and R5 are hydrogen and n is from 10 to 25, preferably from 15 to 23 and more preferably 20. In this even more preferred embodiment of the invention R3 in formula (II) is hydrogen or a cation and preferably a cation selected from the group consisting of Na⁺, K⁺ and NH₄⁺.

Component Z1) of the inventive laundry powder detergent compositions comprises the one or more surfactants preferably in an amount ranging from 10 to 300 wt.-% (weight-%), more preferably from 40 to 250 wt.-%, even more preferably from 50 to 200 wt.-%, especially preferably from 60 to 170 wt.-%, and particularly preferably from 70 to 150 wt.-%, based on the total weight of the magnesium carbonate carrier.

The inventive laundry powder detergent compositions comprise the one or more surfactants on magnesium carbonate carrier of component Z1) preferably in an amount from 0.5 to 50 wt.-%, more preferably in an amount from 1 to 25 wt.-% and even more preferably in an amount from 1.5 to 17 wt.-%, based in each case on the total weight of laundry powder detergent composition.

The carrier material of component Z1) of the laundry detergent compositions of the invention consist of magnesium carbonate, preferably having a specific surface area of >25 m2/g, measured using nitrogen and the BET method according to ISO 9277:2010.

It is appreciated that the term “magnesium carbonate” refers to a material that comprises at least 80 wt.-% magnesium carbonate, e.g. at least 85 wt.-%, preferably between 85 and 100 wt.-%, more preferably between 90 and 99.95 wt.-%, based on the total dry weight of the material. Thus, it is to be noted that the magnesium carbonate may further comprise impurities typically associated with the type of material used. For example, the magnesium carbonate may further comprise impurities such as magnesium hydroxide, calcium hydroxide, calcium carbonate and mixtures thereof. However, such impurities are present in amounts of less than 20 wt.-%, preferably less than 15 wt.-% and more preferably from 0.05 to 10 wt.-%, based on the total dry weight of the material.

The magnesium carbonate can be a naturally occurring or synthetic magnesium carbonate. For example, the magnesium carbonate encompasses naturally occurring or synthetic magnesium carbonate selected from the group comprising magnesite (MgCO₃), hydromagnesite (Mg₅(CO₃)₄(OH)₂.4H₂O), artinite (Mg₂(CO₃)(OH)₂.3H₂O), dypingite (Mg₅(CO₃)₄(OH)₂.5H₂O), giorgiosite (Mg₅(CO₃)₄(OH)₂.5H₂O), pokrovskite (Mg₂(CO₃)(OH)₂.0.5H₂O), barringtonite (MgCO₃.2H₂O, lansfordite (MgCO₃.5H₂O), nesquehonite (MgCO₃.3H₂O) and mixtures thereof.

Preferably, the magnesium carbonate encompasses synthetic magnesium carbonate selected from the group comprising magnesite (MgCO₃), hydromagnesite (Mg₅(CO₃)₄(OH)₂.4H₂O), artinite (Mg₂(CO₃)(OH)₂.3H₂O), dypingite (Mg₅(CO₃)₄(OH)₂.5H₂O), giorgiosite (Mg₅(CO₃)₄(OH)₂.5H₂O), pokrovskite (Mg₂(CO₃)(OH)₂.0.5H₂O), barringtonite (MgCO₃.2H₂O, lansfordite (MgCO₃.5H₂O), nesquehonite (MgCO₃.3H₂O) and mixtures thereof. For example, the magnesium carbonate comprises the synthetic magnesium carbonate selected from the group comprising magnesite (MgCO₃), hydromagnesite (Mg₅(CO₃)₄(OH)₂.4H₂O), artinite (Mg₂(CO₃)(OH)₂.3H₂O), dypingite (Mg₅(CO₃)₄(OH)₂.5H₂O), giorgiosite (Mg₅(CO₃)₄(OH)₂.5H₂O), pokrovskite (Mg₂(CO₃)(OH)₂.0.5H₂O), barringtonite (MgCO₃.2H₂O, lansfordite (MgCO₃.5H₂O), nesquehonite (MgCO₃.3H₂O) and mixtures thereof in an amount of at least 80 wt.-%, preferably at least 85 wt.-%, more preferably between 85 and 100 wt.-%, and even more preferably between 90 and 99.95 wt.-%, based on the total dry weight of the material.

In one embodiment, the magnesium carbonate comprises synthetic hydromagnesite (Mg₅(CO₃)₄(OH)₂.4H₂O). Preferably, the magnesium carbonate comprises synthetic hydromagnesite (Mg₅(CO₃)₄(OH)₂.4H₂O) in an amount of at least 80 wt.-%, more preferably at least 85 wt.-%, even more preferably between 85 and 100 wt.-%, and especially preferably between 90 and 99.95 wt.-%, based on the total dry weight of the material.

A carrier material having a specific surface area of ≥25 m²/g, measured using nitrogen and the BET method according to ISO 9277:2010 has a high loading capacity for surfactant(s) together with a high release efficiency when loaded with surfactant(s). Accordingly, such carrier material is specifically suitable as delivery system for the release of one or more surfactants in laundry powder detergent compositions of the invention.

It is thus one specific requirement of the present invention that the magnesium carbonate has a specific surface area of ≥25 m²/g, measured using nitrogen and the BET method according to ISO 9277:2010. It is preferred that the magnesium carbonate has a specific surface area in the range from 25 to 150 m²/g, more preferably from 35 to 120 m²/g, and even more preferably from 35 to 100 m²/g, measured using nitrogen and the BET method according to ISO 9277:2010.

Furthermore, it is specifically advantageous if the magnesium carbonate has a high intra-particle intruded specific pore volume. For example, it is preferred that the magnesium carbonate has an intra-particle intruded specific pore volume in the range from 0.9 to 2.3 cm³/g, calculated from mercury intrusion porosimetry. In one embodiment, the magnesium carbonate has an intra-particle intruded specific pore volume in the range from 1.1 to 2.1 cm³/g, and more preferably from 1.2 to 2.0 cm³/g, calculated from mercury intrusion porosimetry.

According to one embodiment of the present invention, the magnesium carbonate has
a) a specific surface area of ≥25 m²/g, preferably in the range from 25 to 150 m²/g, more preferably from 35 to 120 m²/g, and especially preferably from 35 to 100 m²/g, measured using nitrogen and the BET method according to ISO 9277:2010, and
b) an intra-particle intruded specific pore volume in the range from 0.9 to 2.3 cm³/g, preferably from 1.1 to 2.1 cm³/g, and more preferably from 1.2 to 2.0 cm³/g, calculated from mercury porosimetry measurement.

Preferably, the magnesium carbonate has a specific surface area in the range from 35 to 100 m²/g, measured using nitrogen and the BET method according to ISO 9277:2010, and an intra-particle intruded specific pore volume in the range from 1.2 to 2.0 cm³/g, calculated from mercury porosimetry measurement.

The magnesium carbonate is in the form of a particulate material and may have a particle size distribution as conventionally employed for the material(s) involved in the type of product to be produced. In general, it is preferred that the magnesium carbonate has a d₅₀(vol) in the range from 1 to 75 μm, as determined by laser diffraction. For example, the magnesium carbonate has a d₅₀(vol) in the range from 1.2 to 50 μm, more preferably from 1.5 to 30 μm, even more preferably from 1.7 to 15 μm and especially preferably from 1.9 to 10 μm, as determined by laser diffraction.

Additionally, or alternatively, the magnesium carbonate has a d₉₈(vol) in the range from 2 to 150 μm, as determined by laser diffraction. For example, the magnesium carbonate has a d₉₈(vol) in the range from 4 to 100 μm, more preferably from 6 to 80 μm, even more preferably from 8 to 60 μm and especially preferably from 10 to 40 μm, as determined by laser diffraction.

Thus, the magnesium carbonate preferably has a
a) a d₅₀(vol) in the range from 1 to 75 μm, preferably from 1.2 to 50 μm, more preferably from 1.5 to 30 μm, even more preferably from 1.7 to 15 μm and especially preferably from 1.9 to 10 μm, as determined by laser diffraction, and
b) a d₉₈(vol) in the range from 2 to 150 μm, preferably from 4 to 100 μm, more preferably from 6 to 80 μm, even more preferably from 8 to 60 μm and especially preferably from 10 to 40 μm, as determined by laser diffraction.

In one embodiment, the magnesium carbonate has a d₅₀(vol) in the range from 1.9 to 10 μm, as determined by laser diffraction, and a d₉₈(vol) in the range from 10 to 40 μm, as determined by laser diffraction.

In order to obtain a carrier material having a high loading capacity together with a high release efficiency when loaded with active agent(s), it is especially preferred that the magnesium carbonate has
a) a specific surface area of 25 m²/g, preferably in the range from 25 to 150 m²/g, more preferably from 35 to 120 m²/g, and even more preferably from 35 to 100 m²/g, measured using nitrogen and the BET method according to ISO 9277:2010, and
b) an intra-particle intruded specific pore volume in the range from 0.9 to 2.3 cm³/g, preferably from 1.1 to 2.1 cm³/g, and more preferably from 1.2 to 2.0 cm³/g, calculated from mercury porosimetry measurement, and
c) a d₅₀(vol) in the range from 1 to 75 μm, preferably from 1.2 to 50 μm, more preferably from 1.5 to 30 μm, even more preferably from 1.7 to 15 μm and especially preferably from 1.9 to 10 μm, as determined by laser diffraction, and/or
d) a d₉₈(vol) in the range from 2 to 150 μm, preferably from 4 to 100 μm, more preferably from 6 to 80 μm, even more preferably from 8 to 60 μm and especially preferably from 10 to 40 μm, as determined by laser diffraction.

Preferably, the magnesium carbonate has
a) a specific surface area of 25 m²/g, preferably in the range from 25 to 150 m²/g, more preferably from 35 to 120 m²/g, and even more preferably from 35 to 100 m²/g, measured using nitrogen and the BET method according to ISO 9277:2010, and
b) an intra-particle intruded specific pore volume in the range from 0.9 to 2.3 cm³/g, preferably from 1.1 to 2.1 cm³/g, and more preferably from 1.2 to 2.0 cm³/g, calculated from mercury porosimetry measurement, and
c) a d₅₀(vol) in the range from 1 to 75 μm, preferably from 1.2 to 50 μm, more preferably from 1.5 to 30 μm, even more preferably from 1.7 to 15 μm and especially preferably from 1.9 to 10 μm, as determined by laser diffraction, and
d) a d₉₈(vol) in the range from 2 to 150 μm, preferably from 4 to 100 μm, more preferably from 6 to 80 μm, even more preferably from 8 to 60 μm and especially preferably from 10 to 40 μm, as determined by laser diffraction.

In one embodiment, the magnesium carbonate has
a) a specific surface area in the range from 35 to 100 m²/g, measured using nitrogen and the BET method according to ISO 9277:2010, and
b) an intra-particle intruded specific pore volume in the range from 1.2 to 2.0 cm³/g, calculated from mercury porosimetry measurement, and
c) a d₅₀(vol) in the range from 1.9 to 10 μm, as determined by laser diffraction, and
d) a d₉₈(vol) in the range from 10 to 40 μm, as determined by laser diffraction.

It is one requirement that the carrier material consists of magnesium carbonate. That is to say, the carrier material contains the magnesium carbonate in an amount of at least 96.0 wt.-%, preferably between 96.0 and 100 wt.-%, more preferably between 99.0 and 99.99 wt.-%, and even more preferably between 99.3 and 99.8 wt.-%, based on the total dry weight of the carrier material.

In one embodiment, the magnesium carbonate contains up to 15 000 ppm Ca²⁺ ions. For example, the magnesium carbonate contains up to 10 000 ppm, more preferably up to 5 000 ppm and even more preferably up to 2 000 ppm Ca²⁺ ions.

Depending on the magnesium carbonate, the magnesium carbonate preferably has a residual total moisture content of from 0.01 to 20 wt.-%, more preferably from 0.01 to 15 wt.-%, even more preferably from 0.02 to 12 wt.-% and especially preferably from 0.04 to 10 wt.-%, based on the total dry weight of the magnesium carbonate. It is appreciated that the total moisture content includes crystal water as well as free water.

### Delivery System

Component Z1) of the laundry powder detergent compositions of the invention is a delivery system for the release of one or more surfactants in the laundry powder detergent compositions of the invention. It is required that the delivery system comprises the carrier material as defined herein, i.e. the magnesium carbonate carrier, and one or more surfactant(s) which is/are loaded on the carrier material.

With regard to the definition of the carrier material and preferred embodiments thereof, reference is made to the statements provided above when discussing the technical details of the carrier material of the present invention.

The delivery system for the release of one or more surfactant(s) in a laundry powder detergent composition of the invention thus comprises
a) a carrier material consisting of magnesium carbonate having a specific surface area of ≥25 m²/g, measured using nitrogen and the BET method according to ISO 9277:2010, and
b) the one or more surfactant(s) which is/are loaded on the carrier material.

Thus, one requirement of the present invention is that one or more surfactant(s) is/are loaded on the carrier material.

The one or more surfactant(s) can be one kind of surfactant. Alternatively, the one or more surfactant(s) can be a mixture of two or more kinds of surfactants.

The one or more surfactant(s) is/are loaded on the carrier material as defined herein. The loading is preferably an adsorption onto the surface of the carrier material, be it the outer or the inner surface of the material or an absorption into the carrier material, which is possible due to its porosity.

In this respect, it is believed that because of the advantageous high specific surface area in combination with a high intra-particle intruded specific pore volume of the magnesium carbonate, this material is a superior carrier material to release previously loaded surfactant(s) over time relative to common carrier materials having lower specific surface areas and/or intra-particle intruded specific pore volume.

Thus, it is appreciated that the one or more surfactant(s) is/are adsorbed onto and/or adsorbed and/or absorbed into the carrier material.

As already mentioned, the delivery system comprises the carrier material as defined herein and one or more surfactant(s) which is/are loaded on the carrier material.

The amount of the one or more surfactant(s) which is/are loaded on the carrier material depends on the surfactant(s) and the intended use. Generally, the delivery system comprises the one or more surfactant(s) in an amount ranging from 10 to 300 wt.-%, based on the total weight of the carrier material.

For example, the delivery system comprises the one or more surfactant(s) in an amount preferably ranging from 40 to 250 wt.-%, more preferably from 50 to 200 wt.-%, even more preferably from 60 to 170 wt.-% and especially preferably from 70 to 150 wt.-%, based on the total weight of the carrier material.

The delivery system can be provided in any form that is conventionally employed for the material(s) involved in the type of product to be produced. It is appreciated that the carrier material is in the form of a particulate material. The term “particulate” in the meaning of the present application refers to a material which is composed of a plurality of particles.

Thus, the delivery system is preferably in the form of a powder or granules. More preferably, the delivery system is in the form of a powder. Such forms and methods for their preparation are well known in the art and do not need to be described in more detail in the present application.

The method for preparing a delivery system for the release of one or more surfactants in a laundry powder detergent composition of the invention comprises the steps of
a) providing magnesium carbonate having a specific surface area of ≥25 m²/g, measured using nitrogen and the BET method according to ISO 9277:2010,
b) providing one or more surfactants in the form of a liquid or dissolved in a solvent, and
c) contacting the magnesium carbonate of step a) with the one or more surfactants of step b).

With regard to the definition of the delivery system, the magnesium carbonate and preferred embodiments thereof, reference is made to the statements provided above when discussing the technical details of the carrier material and the delivery system of the present invention.

The magnesium carbonate may be provided in any suitable liquid or dry form in step a). For example, the magnesium carbonate may be in form of a powder and/or a suspension. The suspension can be obtained by mixing the magnesium carbonate with a solvent, preferably water. The magnesium carbonate to be mixed with a solvent, and preferably water, may be provided in any form, for example, as suspension, slurry, dispersion, paste, powder, a moist filter cake or in pressed or granulated form.

In order to obtain a high loading of the one or more surfactant(s) on the carrier material, it is advantageous to provide the magnesium carbonate as concentrated as possible, i.e. the water content should be as low as possible. Thus, the magnesium carbonate is preferably provided in dry from, i.e. as a powder.

In case the magnesium carbonate is provided in dry form, the moisture content of the magnesium carbonate can be between 0.01 and 20 wt.-%, based on the total weight of the magnesium carbonate. The moisture content of the magnesium carbonate can be, for example, in the range from 0.01 to 15 wt.-%, based on the total weight of the magnesium carbonate, preferably in the range from 0.02 to 12 wt.-%, and more preferably in the range from 0.04 to 10 wt.-%.

According to step b) of the present method, the one or more surfactant(s) is/are provided in the form of a liquid or dissolved in a solvent.

That is to say, in one embodiment the one or more surfactant(s) is/are in the form of a liquid. The term “liquid” with regard to the one or more surfactant(s) refers to non-gaseous fluid surfactant(s), which is/are readily flowable at the pressure conditions and temperature of use, i.e. the pressure and temperature at which the method, preferably method step c), is carried out.

Thus, it is appreciated that the one or more surfactant(s) can be liquid in a temperature range from 5 to 200° C., preferably from 10 to 120° C. and more preferably from 10 to 100° C. For example, the one or more surfactant(s) can be liquid in a temperature range from 5 to 200° C., preferably from 10 to 120° C. and more preferably from 10 to 100° C. at ambient pressure conditions, i.e. at atmospheric pressure. Alternatively, the one or more surfactant(s) can be liquid in a temperature range from 5 to 200° C., preferably from 10 to 120° C. and more preferably from 10 to 100° C. at reduced pressure conditions, e.g. a pressure of from 100 to 700 mbar.

Alternatively, the one or more surfactant(s) is/are dissolved in a solvent. That is to say, the one or more surfactant(s) and the solvent form a system in which no discrete solid particles are observed in the solvent and thus form a “solution”.

In one embodiment of the present invention, the solvent is selected from the group comprising water, methanol, ethanol, n-butanol, isopropanol, n-propanol, acetone, dimethylsulphoxide, dimethylformamide, tetrahydrofurane, vegetable oils and the derivatives thereof, animal oils and the derivatives thereof, molten fats and waxes, and mixtures thereof. Preferably, the solvent is selected from water, alkanes, esters, ethers, alcohols, such as ethanol, ethylene glycol and glycerol, and/or ketones, such as acetone. More preferably, the solvent is water.

The contacting of the magnesium carbonate of step a) with the one or more surfactant(s) of step b) may be carried out in any manner known by the skilled person. The contacting is preferably carried out under mixing. The mixing may be carried out under conventional mixing conditions. The skilled person will adapt these mixing conditions (such as the configuration of mixing pallets and mixing speed) according to his process equipment. It is appreciated that any mixing method which would be suitable to form the delivery system may be used.

It is appreciated that the magnesium carbonate of step a) is loaded with the one or more surfactant(s) of step b) by contacting step c) to form the delivery system.

The loading may be achieved by adding the one or more surfactant(s) to the dry magnesium carbonate.

According to the present invention, the magnesium carbonate is defined to be loaded, if the specific surface area is at least partially covered and/or the intra-particle pore volume of same is at least partially filled by the one or more surfactant(s), and if present, the solvent in which the one or more surfactant(s) is/are dissolved. For example, the magnesium carbonate is loaded, if the specific surface area is at least partially covered and/or the intra-particle pore volume of same is at least partially filled preferably by at least 10 wt.-%, more preferably at least 40 wt.-%, even more preferably at least 50 wt.-%, especially preferably at least 60 wt.-%, and particularly preferably at least 70 wt.-%, based on the total weight of the magnesium carbonate, with the one or more surfactant(s), and if present, the solvent in which the one or more surfactant(s) is/are dissolved. Preferably, the magnesium carbonate is loaded, if the specific surface area is at least partially covered and/or the intra-particle pore volume of same is at least partially filled by 10 to 300 wt.-%, more preferably from 40 to 250 wt.-%, even more preferably from 50 to 200 wt.-%, especially preferably from 60 to 170 wt.-%, and particularly preferably from 70 to 150 wt.-%, based on the total weight of the magnesium carbonate, with the one or more surfactant(s), and if present, the solvent in which the one or more surfactant(s) is/are dissolved.

It is appreciated that method step c) can be carried out over a broad temperature and/or pressure range, provided that the one or more surfactant(s) is/are in liquid form. For example, method step c) is carried out in a temperature range from 5 to 200° C., preferably from 10 to 120° C. and more preferably from 10 to 100° C. at ambient pressure conditions, i.e. at atmospheric pressure. Alternatively, method step c) is carried out in a temperature range from 5 to 200° C., preferably from 10 to 120° C. and more preferably from 10 to 100° C. at reduced pressure conditions, e.g. a pressure of from 100 to 700 mbar.

In one embodiment, method step c) is carried out at ambient temperature and pressure conditions, e.g., at room temperature, such as from about 5 to 35° C., preferably from 10 to 30° C. and more preferably from 15 to 25° C., and at atmospheric pressure. This embodiment preferably applies in case the one or more surfactant(s) is/are liquid at room temperature or are dissolved in a solvent.

In case the one or more surfactant(s) is/are dissolved in a solvent, the solvent is preferably removed after method step c), e.g. by evaporation. In this embodiment, the method thus preferably comprises a further step of separating the prepared delivery system from the excess solvent.

The solvent is preferably removed by means of separating the solvent from the loaded magnesium carbonate. This is preferably achieved by drying by means selected from the group comprising drying in a rotational oven, jet-drying, fluidized bed drying, freeze drying, flash drying, and temperature-controlled high or low shear mixer.

The delivery system according to the present invention may thus be produced by a method comprising the following steps:
a) providing magnesium carbonate having a specific surface area of ≥25 m²/g, measured using nitrogen and the BET method according to ISO 9277:2010,
b) providing one or more surfactant(s) dissolved in a solvent,
c) contacting the magnesium carbonate of step a) with the one or more surfactant(s) of step b), and d) separating the delivery system formed in step c) from the excess solvent.

The method may further comprise an optional step e) of granulating the mixture obtained in step c) or optional step d) for obtaining granules of the desired form and size.

The granulation equipment may be selected from the conventionally used ones for granulation purposes. Thus, the granulation device may be selected from the group comprising Eirich mixers, fluidized bed dryers/granulators, plate granulators, table granulators, drum granulators, disc granulators, dish granulators, ploughshare mixer, vertical or horizontal mixers, high or low shear mixer, high speed blenders, roller compactor and rapid mixer granulators.

It might be noted that there may be differences as regards the granule sizes or granule size distributions to be achieved depending on the method used.

For example, the use of a fluidized bed mixer for granulation appears to provide a more uniform granule size distribution than the Lödige mixer, whereas the Lödige mixer gives a wider size distribution. Thus, multiple size ranges may be provided.

In one embodiment, the method for preparing a delivery system for the release of one or more surfactant(s) in a laundry powder detergent composition of the invention comprises the steps of
a) providing magnesium carbonate having a specific surface area of ≥25 m²/g, measured using nitrogen and the BET method according to ISO 9277:2010,
b) providing one or more surfactant(s) in the form of a liquid or dissolved in a solvent,
c) contacting the magnesium carbonate of step a) with the one or more surfactant(s) of step b),
d) optionally separating the delivery system formed in step c) from the excess solvent, and
e) granulating the delivery system formed in step c) or optional step d) for obtaining granules.

It is appreciated that the carrier material has a high loading capacity for surfactant(s) together with a high release efficiency when loaded with surfactant(s).

It is appreciated that the delivery system provides a release efficiency for the one or surfactant(s) represented by the following formula (I)

$$release efficiency = 100 ⋆ \frac{m ( surfactant released )}{m ( surfactant loaded )} of \geq 50 \% . \qquad ( I )$$

Preferably, the delivery system provides a release efficiency for the one or more surfactant (s) represented by the formula (I) of ≥72%, and more preferably ≥80%.

It is preferred that the release efficiency is attained within a time period of 15 min, preferably within 5 min and more preferably within 1 min.

### Particle Size Distribution

Volume determined median particle size d₅₀(vol) and the volume determined top cut particle size d₉₈(vol) is evaluated using a Malvern Mastersizer 3000 Laser Diffraction System (Malvern Instruments Pic., Great Britain) equipped with a Hydro LV system. The d₅₀(vol) or d₉₈(vol) value indicates a diameter value such that 50% or 98% by volume, respectively, of the particles have a diameter of less than this value. The powders are suspended in 0.1 wt.-% Na₄O₇P₂ solution. 10 mL of 0.1 wt.-% Na₄O₇P₂ is added to the Hydro LV tank, then the sample slurry is introduced until an obscuration between 10-20% is achieved and the system is ultrasonicated at the 40% setting for 1 min. Measurements are conducted with red and blue light for 10 s each. For the analysis of the raw data, the models for non-spherical particle sizes with the Fraunhofer assumption is utilized, and a particle refractive index of 1.57, a density of 2.70 g/cm³, and an absorption index of 0.005 is assumed. The methods and instruments are known to the skilled person and are commonly used to determine particle size distributions of fillers and pigments.

### Specific Surface Area (SSA)

The specific surface area is measured via the BET method according to ISO 9277:201 using nitrogen as adsorbing gas on a Micromeritics ASAP 2460 instrument from Micromeritics. The samples are pretreated in vacuum (10⁻⁵ bar) by heating at 100° C. for a period of 120 min prior to measurement.

### Intra-Particle Intruded Specific Pore Volume (in Cm³/g)

The specific pore volume is measured using a mercury intrusion porosimetry measurement using a Micromeritics Autopore V 9620 mercury porosimeter having a maximum applied pressure of mercury 414 MPa (60 000 psi), equivalent to a Laplace throat diameter of 0.004 μm (˜nm). The equilibration time used at each pressure step is 20 seconds. The sample material is sealed in a 3 cm′ chamber powder penetrometer for analysis. The data are corrected for mercury compression, penetrometer expansion and sample material compression using the software Pore-Camp (Gane, P. A. C., Kettle, J. P., Matthews, G. P. and Ridgway, C. J., “Void Space Structure of Compressible Polymer Spheres and Consolidated Calcium Carbonate Paper-Coating Formulations”, Industrial and Engineering Chemistry Research, 35(5), 1996, p 1753-1764.).

The total pore volume seen in the cumulative intrusion data can be separated into two regions with the intrusion data from 208 μm down to about 1-4 μm showing the coarse packing of the sample between any agglomerate structures contributing strongly. Below these diameters lies the fine inter-particle packing of the particles themselves. If they also have intra-particle pores, then this region appears bi-modal, and by taking the specific pore volume intruded by mercury into pores finer than the modal turning point, i.e. finer than the bi-modal point of inflection, the specific intra-particle pore volume is defined. The sum of these three regions gives the total overall pore volume of the powder, but depends strongly on the original sample compaction/settling of the powder at the coarse pore end of the distribution.

By taking the first derivative of the cumulative intrusion curve the pore size distributions based on equivalent Laplace diameter, inevitably including pore-shielding, are revealed. The differential curves clearly show the coarse agglomerate pore structure region, the inter-particle pore region and the intra-particle pore region, if present. Knowing the intra-particle pore diameter range it is possible to subtract the remainder inter-particle and inter-agglomerate pore volume from the total pore volume to deliver the desired pore volume of the internal pores alone in terms of the pore volume per unit mass (specific pore volume). The same principle of subtraction, of course, applies for isolating any of the other pore size regions of interest.

### Chemical Oxygen Demand Analysis

For chemical oxygen demand (COD) analysis, suspensions are filtered (Chromafil© Xtra RC-20/25 syringe filter) and adequately diluted for the analysis. Active concentrations are determined using a cell test (according to ISO 15705; Spectroquant® for non-Merck photometers; 0-1500 mg L⁻¹) in an Aqualytics COD250 varia photometer. For each sample, 5 readings are taken and the result averaged. The concentration of the samples is calculated based on a calibration curve with previously prepared standard solutions.

### Loading of the Carrier Materials

For loading experiments, 10 g of the carrier material is weighed into a beaker and mechanically stirred. Then, the desired amount of surfactant solution is added dropwise using a pipette. Solid surfactants are dissolved in water at a suitable concentration before the loading procedure. The nominal loading of surfactants is calculated according to equation (I).

$$Loading [ \% ] = \frac{mass of surfactant [ g ]}{mass of powder [ g ]} \cdot 100 \qquad ( I )$$

### Component Z2)

Preferably, the one or more anionic surfactants which are not present on a carrier Z2) of the inventive laundry powder detergent compositions are selected from the group consisting of sulfate surfactants and sulfonate surfactants.

More preferably, the one or more sulfate surfactants which are not present on a carrier Z2) of the inventive laundry powder detergent compositions are selected from the group consisting of linear or branched, saturated alkyl sulfates, preferably having from 8 to 20 carbon atoms, linear or branched unsaturated alkenyl sulfates having one or more double bonds and preferably from 8 to 20 carbon atoms, linear or branched, saturated alkyl ether sulfates, preferably having from 8 to 20 carbon atoms and preferably having from 0.5 to 16 alkyleneoxy units, preferably ethyleneoxy units, propyleneoxy units or mixtures of ethyleneoxy and propyleneoxy units, and linear or branched unsaturated alkenyl ether sulfates having one or more double bonds, preferably having from 8 to 20 carbon atoms and preferably having from 0.5 to 16 alkyleneoxy units, preferably ethyleneoxy units, propyleneoxy units or mixtures of ethyleneoxy and propyleneoxy units.

More preferably, the one or more sulfonate surfactants which are not present on a carrier Z2) of the inventive laundry powder detergent compositions are selected from the group consisting of linear or branched, preferably linear, alkylbenzene sulfonates, wherein the alkyl group is saturated and preferably has from 8 to 18 carbon atoms, more preferably from 10 to 14 carbon atoms, linear or branched alkyl sulfonates, wherein the alkyl group is saturated and preferably has from 8 to 18 carbon atoms, more preferably from 10 to 16 carbon atoms, linear or branched alkyl xylene sulfonates, wherein the alkyl group is saturated and preferably has from 8 to 18 carbon atoms, more preferably from 10 to 14 carbon atoms, and fatty acid ester sulfonates, wherein the fatty acid group preferably has from 8 to 20 carbon atoms, more preferably from 12 to 18 carbon atoms.

The inventive laundry powder detergent compositions comprise the one or more anionic surfactants which are not present on a carrier Z2) preferably in an amount from 1 to 50 wt.-% and more preferably in an amount from 5 to 30 wt.-%, based in each case on the total weight of the inventive laundry powder detergent composition.

Preferably, the inventive laundry powder detergent compositions comprise not only the one or more surfactants on magnesium carbonate carrier Z1) and the one or more anionic surfactants which are not present on a carrier Z2), but also one or more further substances selected from the components Z3), Z4), Z5), and/or Z6)
Z3) one or more fatty alcohol alkoxylates, preferably fatty alcohol ethoxylates, as component Z3),
Z4) one or more detergent builders as component Z4),
Z5) one or more bleaching compounds as component Z5),
Z6) one or more further additives as component Z6), preferably selected from the group consisting of enzymes, enzyme stabilizers, polymeric soil release agents, chelating agents, anti-redeposition agents, polymeric dispersing agents, brighteners, suds suppressors, fabric softeners, dye transfer inhibiting agents.

The pH of the inventive laundry powder detergent compositions at 20° C. preferably is from 7 to 14, more preferably from 8 to 12 and even more preferably from 9 to 11.5, measured as a 10 wt.-% solution of the inventive laundry powder detergent compositions in water.

### Alcohol Alkoxylates (Component Z3)

Preferably, the inventive laundry powder detergent compositions contain one or more fatty alcohol alkoxylates, preferably fatty alcohol ethoxylates. Preferably, the fatty alcohol alkoxylates are selected from the formula (VII)

R6-O-(AO)ₘ—H (VII)

wherein
R6 is a linear or branched, substituted or non-substituted, saturated alkyl group or unsaturated alkenyl group having one or more double bonds, preferably having 6 to 30 carbon atoms, more preferably 8 to 22 carbon atoms, even more preferably 10 to 20 carbon atoms and especially preferably 12 to 18 carbon atoms, and preferably is a linear non-substituted saturated alkyl group, preferably having 6 to 30 carbon atoms, more preferably 8 to 22 carbon atoms, even more preferably 10 to 20 carbon atoms and especially preferably 12 to 18 carbon atoms,
AO is an ethylene oxide (E0) or propylene oxide (PO) group, preferably an ethylene oxide group,
m is a number from 1 to 50, preferably from 1 to 20, more preferably from 2 to 10, and even more preferably is 2, 3, 4, 5, 6, 7 or 8.

In one particularly preferred embodiment of the invention, R6 in formula (VII) is selected from the group consisting of decyl, undecyl, dodecyl, tridecyl, tetradecyl, pentadecyl, hexadecyl, heptadecyl, octadecyl, nonadecyl, eicosyl and mixtures thereof.

In another particularly preferred embodiment of the invention, R6 in formula (VII) is derived from one or more fatty alcohols, preferably from one or more fatty alcohols having from 6 to 30 carbon atoms, more preferably from one or more fatty alcohols having from 8 to 22 carbon atoms, even more preferably from one or more fatty alcohols having from 10 to 20 carbon atoms and especially preferably from one or more fatty alcohols having from 12 to 18 carbon atoms.

In another particularly preferred embodiment of the invention, R6 in formula (VII) is derived from the group of alcohols consisting of coco fatty alcohol, cetearyl alcohol, lauryl alcohol, myristyl alcohol, cetyl alcohol, stearyl alcohol and mixtures thereof.

In another particularly preferred embodiment of the invention, R6 in formula (VII) is derived from one or more oxo alcohols having from 10 to 20 carbon atoms.

The variable “m” in the one or more compounds of the formula (VII) above preferably represents molar averages, meaning that the inventive laundry powder detergent compositions of the invention may comprise a plurality of compounds of the formula (VII) having different degrees of alkoxylation.

The inventive laundry powder detergent compositions preferably comprise from 0 to 30 wt.-%, more preferably from 1 to 30 wt.-% and even more preferably from 5 to 25 wt.-% of the one or more fatty alcohol alkoxylates of component Z3).

### Detergent Builders (Component Z4)

Preferably, detergent builders are included in the inventive laundry powder detergent compositions to assist in controlling mineral hardness and in the removal of particulate soils. Inorganic as well as organic detergent builders can be used.

The level of detergent builders can vary widely depending upon the end use of the inventive laundry powder detergent compositions and its desired physical form. The inventive laundry powder detergent compositions preferably comprise from 1 to 90 wt.-%, more preferably from 10 to 80 wt.-% and even more preferably from 15 to 50 wt.-% of the detergent builders of component Z4).

Inorganic detergent builders include, but are not limited to, the alkali metal, ammonium and alkanolammonium salts of polyphosphates (exemplified by the tripolyphosphates, pyrophosphates and glassy polymeric meta-phosphates), phosphonates, phytic acid, silicates, carbonates (including bicarbonates and sesquicarbonates), sulphates and aluminosilicates. However, non-phosphate builders are required in many locals nowadays. Importantly, the inventive laundry powder detergent compositions could function even in the presence of the so-called “weak” detergent builders (as compared with phosphates) such as citrate, or in the so-called “underbuilt” situation that may occur with zeolite or layered silicate builders. Moreover, the secondary alkyl sulfate plus enzyme components perform best in the presence of weak, non-phosphate builders which allow free calcium ions to be present.

Examples of silicate detergent builders are the alkali metal silicates, particularly those having a SiO₂:Na₂O ratio in the range from 1.6:1 to 3.2:1 and layered silicates, such as NaSKS-6. Unlike zeolite builders, the Na SKS-6 silicate builder does not contain aluminum. NaSKS-6 has the delta-Na₂SiO₅ morphology form of layered silicate. SKS-6 is a highly preferred layered silicate for use herein, but other such layered silicates, such as those having the general formula NaMSiₓO₂ₓ₊₁.yH₂O wherein M is sodium or hydrogen, x is a number from 1.9 to 4, preferably 2 and y is a number from 0 to 20, preferably 0 can be used herein. Various other layered silicates include NaSKS-5, NaSKS-7 and NaSKS-11, as the alpha, beta and gamma forms. As noted above, the delta-Na₂SiO₅ (NaSKS-6 form) is most preferred for use herein. Other silicates may also be useful such as for example magnesium silicate, which can serve as a crispening agent, as a stabilizing agent for oxygen bleaches and as a component of suds control systems.

Examples of carbonate detergent builders are alkaline earth and alkali metal carbonates.

Aluminosilicate builders are of great importance in most currently marketed laundry powder detergent compositions. Aluminosilicate builders include those having the empirical formula (III):

M_{z}(zAlO₂.ySiO₂) (III)

wherein
M is Na⁺, K⁺, NH₄⁺ or substituted ammonium,
z is from 0.5 to 2; and
y is 1;
   this material having a magnesium ion exchange capacity of at least 50 milligram equivalents of CaCO₃ hardness per gram of anhydrous aluminosilicate. Preferred aluminosilicates are zeolite builders which have the formula:

Na_{z}[(AlO₂)_{z}(SiO₂)_{y}]xH₂O (IV)

wherein
z and y are integers of at least 6, the molar ratio of z to y is in the range from 1.0 to 0.5, and
x is an integer from 15 to 264.

Useful aluminosilicate ion exchange materials are commercially available. These aluminosilicates can be crystalline or amorphous in structure and can be naturally-occurring aluminosilicates or synthetically derived. Preferred synthetic crystalline aluminosilicate ion exchange materials useful herein are available under the designations Zeolite A, Zeolite P (B), and Zeolite X. In an especially preferred embodiment, the crystalline aluminosilicate ion exchange material has the formula (V):

Na₁₂[(AlO₂)₁₂(SiO₂)₁₂].xH₂O (V)

wherein
x is from 20 to 30, especially 27.

This material is known as Zeolite A. Preferably, the aluminosilicate has a particle size of 0.1-10 microns in diameter.

Organic detergent builders include, but are not restricted to, a wide variety of polycarboxylate compounds. As used herein, “polycarboxylate” refers to compounds having a plurality of carboxylate groups, preferably at least 3 carboxylates. Polycarboxylate detergent builder can generally be added to the inventive laundry powder detergent compositions in acid form but can also be added in the form of a neutralized salt. When utilized in salt form, alkali metals, such as Na⁺, K⁺ and Li⁺ or alkanolammonium salts are preferred.

Included among the polycarboxylate detergent builders are a variety of categories of useful materials. One important category of polycarboxylate detergent builders encompasses ether polycarboxylates, including oxydisuccinate. Suitable ether polycarboxylates also include cyclic compounds, particularly alicyclic compounds.

Other useful detergent builders include the ether hydroxypolycarboxylates, copolymers of maleic anhydride with ethylene or vinyl methyl ether, 1,3,5-trihydroxy benzene-2,4,6-trisulphonic acid and carboxymethyloxysuccinic acid, the various alkali metal, NH₄⁺ and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid and soluble salts thereof.

Citrate detergent builders, e.g., citric acid and soluble salts thereof (particularly sodium salt), are polycarboxylate detergent builders of particular importance due to their availability from renewable resources and their biodegradability. Citrates are typically used in laundry powder detergent compositions in combination with zeolite and/or layered silicate builders. Oxydisuccinates are also useful in the inventive laundry powder detergent compositions.

Also suitable in the inventive laundry powder detergent compositions of the present invention are 3,3-dicarboxy-4-oxa-1,6-hexanedioates and related compounds. Useful succinic acid detergent builders include the alkyl and alkenyl succinic acids having 5 to 10 carbon atoms and their salts. A particularly preferred compound of this type is dodecenylsuccinic acid. Specific examples of succinate detergent builders include: laurylsuccinate, myristylsuccinate, palmitylsuccinate, 2-dodecenylsuccinate (preferred), 2-pentadecenylsuccinate and the like. Laurylsuccinates are the preferred detergent builders of this group.

Fatty acids, e.g. monocarboxylic acids having 12 to 18 carbon atoms, can also be incorporated into the inventive laundry powder detergent compositions alone, or in combination with the aforesaid detergent builders, especially citrate and/or the succinate detergent builders, to provide additional builder activity. Such use of fatty acids will generally result in a diminution of sudsing, which should be considered by the formulator.

In situations where phosphorus-based detergent builders can be used, the various alkali metal phosphates such as the well-known sodium tripolyphosphates, sodium pyrophosphate and sodium orthophosphate can be used. Phosphonate detergent builders such as ethane-1-hydroxy-1,1-diphosphonate and other known phosphonates can also be used.

### Bleaching Compounds (Component Z5)

The inventive laundry powder detergent compositions herein may optionally contain bleaching agents or bleaching compounds containing a bleaching agent and one or more bleach activators. The inventive laundry powder detergent compositions preferably comprise from 0 to 30 wt.-%, more preferably from 1 to 30 wt.-%, and even more preferably from 5 to 20 wt.-% of the one or more bleaching compounds, in each case based on the total weight of the inventive laundry powder detergent compositions. If present, the amount of bleach activators will preferably be from 0.1 to 60 wt.-%, more preferably from 0.5 to 40 wt.-% of the bleaching compounds comprising the bleaching agent plus bleach activator.

Preferably, the bleaching compounds used herein can comprise any of the bleaching agents useful for the inventive laundry powder detergent compositions in textile cleaning, hard surface cleaning, or other cleaning purposes that are now known or become known. These include oxygen bleaching agents as well as other bleaching agents. Perborate bleaching agents, e.g., sodium perborate (e.g. mono- or tetra-hydrate) can be used herein.

One category of bleaching agent that can be used without restriction encompasses percarboxylic acid bleaching agents and salts thereof. Suitable examples of this class of bleaching agents include magnesium monoperoxyphthalate hexahydrate, the magnesium salt of meta-chloro perbenzoic acid, 4-nonylamino-4-oxoperoxybutyric acid and diperoxy-dodecanedioic acid. Highly preferred bleaching agents also include 6-nonylamino-6-oxoperoxycaproic acid.

Peroxygen bleaching agents can also be used. Suitable peroxygen bleaching agents are sodium carbonate peroxyhydrate and equivalent “percarbonate” bleaching agents, sodium pyrophosphate peroxyhydrate, urea peroxyhydrate, and sodium peroxide. Persulfate bleach (e.g. OXONE (tradename) manufactured commercially by DuPont) can also be used.

Mixtures of bleaching agents can also be used.

Peroxygen bleaching agents, the perborates, the percarbonates, etc., are preferably combined with bleach activators, which lead to the in-situ production in aqueous solution (i.e. during the washing process) of the peroxy acid corresponding to the bleach activator. The nonanoyloxybenzene sulfonate (NOBS) and tetraacetyl ethylenediamine (TAED) bleach activators are typical and mixtures thereof can also be used.

Bleaching agents other than oxygen bleaching agents are also known in the art and can be utilized herein. One type of non-oxygen bleaching agent of particular interest includes photoactivated bleaching agents such as the sulfonated zinc and/or aluminum phthalocyanines. If used, the inventive laundry powder detergent compositions will typically contain from 0.025 to 1.25 wt.-% of such bleaching agents, especially sulfonated zinc phthalocyanine, based on the total weight of the inventive laundry powder detergent composition.

### Further Additives (Component Z6)

Preferably, the inventive laundry powder detergent compositions can optionally include one or more further additives, e.g. for assisting or enhancing cleaning performance, treatment of the substrate to be cleaned, or to modify the aesthetics of the inventive laundry powder detergent compositions. The following are illustrative examples of such further additives.

### Enzymes

Enzymes can be included in the inventive laundry powder detergent compositions herein for a wide variety of textile cleaning purposes, including removal of protein-based, carbohydrate-based, or triglyceride-based stains, for example, and for the prevention of refugee dye transfer, and for fabric restoration. The enzymes to be incorporated include proteases, amylases, lipases, cellulases, and peroxidases, as well as mixtures thereof. Other types of enzymes may also be included. They may be of any suitable origin, such as vegetable, animal, bacterial, fungal and yeast origin. However, their choice is governed by several factors such as pH-activity and/or stability optima, thermostability, stability versus active deter-gents, builders and so on. In this respect bacterial or fungal enzymes are preferred, such as bacterial amylases and proteases, and fungal cellulases.

Enzymes are normally incorporated at levels sufficient to provide up to about 5 mg by weight, more typically 0.01 to 3 mg of active enzyme per gram of a laundry powder detergent composition. The laundry powder detergent compositions typically comprise from 0.001 to 5 wt.-%, preferably from 0.01 to 1 wt.-% of a commercial enzyme preparation. Protease enzymes are usually present in such commercial preparations at levels sufficient to provide from 0.005 to 0.1 Anson units (AU) of activity per gram of the laundry powder detergent compositions.

Suitable examples of proteases are the subtilisins which are obtained from particular strains of B. subtilis and B. licheniforms. Another suitable protease is obtained from a strain of Bacillus, having maximum activity throughout the pH ranging from 8 to 12, developed and sold by Novo Industries A/S under the registered trade name ESPERASE. Proteolytic enzymes suitable for removing protein-based stains that are commercially available include those sold under the tradenames ALCALASE, SAVINASE and MAXATASE. Other proteases include Protease A and Protease B.

Amylases include, for example, alpha-amylases, RAPIDASE (tradename) and TERMAMYL (tradename).

The cellulases usable in the present invention include both bacterial or fungal cellulase. Preferably, they will have a pH optimum of between 5 and 9.5.

Suitable lipase enzymes for the inventive laundry powder detergent compositions include those produced by microorganisms of the Pseudomonas group, such as Pseudomonas stutzeri ATCC 19.154 or lipases such as Lipase P “Amano”, hereinafter referred to as “Amano-P.” Other commercial lipases include Amano-CES, lipases ex Chromobacter viscosum, e.g. Chromobacter viscosum var. lipolyticum NRRLB 3673, Chromobacter viscosum lipases, and lipases ex Pseudomonas gladioli. The LIPOLASE (tradename) enzyme derived from Humicola lanuginosa is a preferred lipase for use herein.

Peroxidase enzymes are used in combination with oxygen sources, e.g., percarbonate, perborate, persulfate, hydrogen peroxide, etc. They are used for “solution bleaching,” i.e. to prevent transfer of dyes or pigments removed from substrates during wash operations to other substrates in the wash solution. Peroxidase enzymes are known in the art, and include, for example, horseradish peroxidase, ligninase, and haloperoxidase such as chloro- and bromo-peroxidase. Peroxidase-containing laundry powder detergent compositions, enzyme additives useful for the inventive laundry powder detergent compositions, and their incorporation into such laundry powder detergent compositions are known in the art. Enzymes for use in the inventive laundry powder detergent compositions can be stabilized by various techniques.

### Enzyme Stabilizers

The enzymes employed herein can be stabilized by the presence of water-soluble sources of Ca²⁺ and/or Mg²⁺ ion in the inventive laundry powder detergent compositions which provides such ions to the enzymes. (Ca²⁺ ions are generally somewhat more effective than Mg²⁺ ion and are preferred herein if only one type of cation is being used.) Additional stability can be provided by the presence of various other art-disclosed enzyme stabilizers, especially borate species. Typical laundry powder detergent compositions will comprise from 1 to 30, preferably from 2 to 20, more preferably from 5 to 15, and most preferably from 8 to 12 millimoles of calcium ion per kilo of laundry powder detergent compositions. This can vary somewhat, depending on the amount of enzyme present and its response to the calcium or magnesium ions. The level of calcium or magnesium ions should be selected so that there is always some minimum level available for the enzyme, after allowing for complexation with detergent builders, fatty acids, etc., in a laundry powder detergent composition. Any water-soluble Ca²⁺ or Mg²⁺ salt can be used as the source of Ca²⁺ or Mg²⁺ ions, including, but not limited to, calcium chloride, calcium sulfate, calcium malate, calcium maleate, calcium hydroxide, calcium formate, and calcium acetate, and the corresponding Mg²⁺ salts. A small amount of calcium ion, generally from 0.05 to 0.4 millimoles per kilo, is often also present in a laundry powder detergent composition due to Ca²⁺ in the enzyme slurry and formula water. In the alternative, natural water hardness may suffice.

It is to be understood that the foregoing levels of Ca²⁺ and/or Mg²⁺ ions are sufficient to provide enzyme stability. More Ca²⁺ and/or Mg²⁺ ions can be added the inventive laundry powder detergent compositions to provide an additional measure of grease removal performance. Accordingly, the inventive laundry powder detergent compositions may comprise from 0.05 to 2 wt.-% of a water-soluble source of Ca²⁺ or Mg²⁺ ions, or both. The amount can vary with the amount and type of enzyme employed in the inventive laundry powder detergent compositions.

The inventive Laundry powder detergent compositions may also optionally, but preferably, contain various additional enzyme stabilizers, especially borate-type enzyme stabilizers. Typically, such enzyme stabilizers will be used at levels in the inventive laundry powder detergent compositions from 0.25 to 10 wt.-%, preferably from 0.5 to 5 wt.-% and more preferably from 0.75 to 3 wt.-% of boric acid or other borate compound capable of forming boric acid in the inventive laundry powder detergent compositions (calculated on the basis of boric acid). Boric acid is preferred, although other compounds such as boric oxide, borax and other alkali metal borates (e.g. sodium ortho-, meta- and pyroborate, and sodium pentaborate) are suitable substituted boric acids (e.g. phenylboronic acid, butane boronic acid, and p-bromo phenylboronic acid) can also be used in place of boric acid.

### Polymeric Soil Release Agent

Any polymeric soil release agent known to those skilled in the art can optionally be employed in the inventive laundry powder detergent compositions and processes of this invention. Polymeric soil release agents are characterized by having both hydrophilic segments, to hydrophilize the surface of hydrophobic fibers, such as polyester and nylon, and hydrophobic segments, to deposit upon hydrophobic fibers and remain adhered thereto through completion of washing and rinsing cycles and, thus, serve as an anchor for the hydrophilic segments. This can enable stains occurring subsequent to treatment with the polymeric soil release agent to be more easily cleaned in later washing procedures.

The polymeric soil release agents useful herein especially include those polymeric soil release agents having: a) one or more nonionic hydrophile components consisting essentially of (i) polyoxyethylene segments with a degree of polymerization of at least 2, or (ii) oxypropylene or polyoxypropylene segments with a degree of polymerization of from 2 to 10, wherein said hydrophile segment does not encompass any oxypropylene unit unless it is bonded to adjacent moieties at each end by ether linkages, or (iii) a mixture of oxyalkylene units comprising oxyethylene and from 1 to 30 oxypropylene units wherein said mixture contains a sufficient amount of oxyethylene units such that the hydrophile component has hydrophilicity great enough to increase the hydrophilicity of conventional polyester synthetic fiber surfaces upon deposit of the polymeric soil release agent on such surface, said hydrophile segments preferably comprising at least 25% oxyethylene units and more preferably, especially for such components having 20 to 30 oxypropylene units, at least 50% oxyethylene units; or b) one or more hydrophobe components comprising (i) oxypropylene terephthalate segments, wherein, if said hydrophobe components also comprise oxyethylene terephthalate, the ratio of oxyethylene terephthalate:oxypropylene terephthalate units is about 2:1 or lower, (ii) alkylene having 4 to 6 carbon atoms or oxyalkylene having 4 to 6 carbon atoms segments, or mixtures therein, (iii) poly (vinyl ester) segments, preferably poly(vinyl acetate), having a degree of polymerization of at least 2, or (iv) alkyl ether having 1 to 4 carbon atoms or hydroxyalkyl ether, having 4 carbon atoms, substituents, or mixtures therein, wherein said substituents are present in the form of alkyl ether having 4 carbon atoms or hydroxyalkyl ether having 4 carbon atoms cellulose derivatives, or mixtures therein, and such cellulose derivatives are amphiphilic, whereby they have a sufficient level of alkyl ether having 1 to 4 carbon atoms and/or hydroxyalkyl ether units having 4 carbon atoms to deposit upon conventional polyester synthetic fiber surfaces and retain a sufficient level of hydroxyls, once adhered to such conventional synthetic fiber surface, to increase fiber surface hydrophilicity, or a combination of a) and b).

Typically, the polyoxyethylene segments of a) (i) will have a degree of polymerization of from 2 to 200, although higher levels can be used, preferably from 3 to 150 and more preferably from 6 to 100. Suitable oxyalkylene having 4 to 6 carbon atoms hydrophobe segments include, but are not limited to, endcaps of polymeric soil release agents such as MO₃S(CH₂)ₙOCH₂CH₂O—, where M is sodium and n is an integer from 4 to 6.

Polymeric soil release agents useful in the present invention also include cellulosic derivatives such as hydroxyether cellulosic polymers, copolymeric blocks of ethylene terephthalate or propylene terephthalate with polyethylene oxide or polypropylene oxide terephthalate, and the like. Such agents are commercially available and include hydroxyethers of cellulose such as METHOCEL (tradename). Cellulosic polymeric soil release agents for use herein also include those selected from the group consisting of alkyl having 1 to 4 atoms and hydroxyalkyl having 4 atoms cellulose.

Polymeric soil release agents characterized by poly(vinyl ester) hydrophobe segments include graft copolymers of poly (vinyl ester), e.g., vinyl having 1 to 6 carbon atoms esters, preferably poly(vinyl acetate) grafted onto polyalkylene oxide backbones, such as polyethylene oxide backbones. Commercially available polymeric soil release agents of this kind include the SOKALAN (tradename) type of material, e.g., SOKALAN (tradename) HP-22.

One type of polymeric soil release agent is a copolymer having random blocks of ethylene terephthalate and polyethylene oxide (PEO) terephthalate. The molecular weight of this polymeric soil release agent is in the range of from 25,000 to 55,000.

Another polymeric soil release agent is a polyester with repeat units of ethylene terephthalate units containing from 10 to 15 wt.-% of ethylene terephthalate units together with from 90 to 80 wt.-% of polyoxyethylene terephthalate units, derived from a polyoxyethylene glycol of average molecular weight from 300 to 5,000. Examples of this polymer include the commercially available material ZELCON (tradename) 5126 and MILEASE T (tradename).

Another polymeric soil release agent is a sulfonated product of a substantially linear ester oligomer comprised of an oligomeric ester backbone of terephthaloyl and oxyalkyleneoxy repeat units and terminal moieties covalently attached to the backbone.

Other suitable polymeric soil release agents include terephthalate polyesters, anionic end-capped oligomeric esters, and block polyester oligomeric compounds.

Still other polymeric soil release agents also include the polymeric soil release agents, e.g. anionic, especially sulfoaroyl, endcapped terephthalate esters.

If utilized, polymeric soil release agents will generally comprise from 0.01 to 10.0 wt.-%, preferably from 0.1 to 5 wt.-% and more preferably from 0.2 to 3 wt.-% of the inventive laundry powder detergent compositions.

### Chelating Agents

The inventive laundry powder detergent compositions herein may also optionally contain one or more iron and/or manganese chelating agents. Such chelating agents can be selected from the group consisting of amino carboxylates, amino phosphonates, polyfunctionally-substituted aromatic chelating agents and mixtures therein, all as hereinafter defined. Without intending to be bound by theory, it is believed that the benefit of these materials is due in part to their exceptional ability to remove Fe³⁺ and Mg²⁺ ions from washing solutions by formation of soluble chelates.

Amino carboxylates useful as optional chelating agents include ethylenediaminetetraacetates, N-hydroxyethylethylenediaminetriacetates, nitrilotriacetates, ethylenediamine tetraproprionates, triethylenetetraam inehexaacetates, diethylenetriam inepentaacetates and ethanoldiglycines, alkali metal, NH₄⁺, and substituted ammonium salts therein and mixtures therein.

Amino phosphonates are also suitable for use as chelating agents in the inventive laundry powder detergent compositions of the invention when at least low levels of total phosphorus are permitted in the inventive laundry powder detergent compositions and include ethylenediaminetetrakis (methylenephosphonates), nitrilotris (methylenephosphonates) and diethylenetriaminepentakis (methylenephospho-nates) as DEQUEST (tradename). Preferably, these amino phosphonates do not contain alkyl or alkenyl groups with more than 6 carbon atoms.

Polyfunctionally-substituted aromatic chelating agents are also useful in the inventive laundry powder detergent compositions herein. Preferred compounds of this type in acid form are dihydroxydisulfobenzenes such as 1,2-dihydroxy-3,5-disulfobenzene.

A preferred biodegradable chelating agent for use herein is ethylenediamine disuccinate (“EDDS”).

If utilized, chelating agents will generally comprise from 0.1 to 10 wt.-%, preferably 0.1 to 3 wt.-%, of the inventive laundry powder detergent compositions herein.

### Anti-Redeposition Agents

The inventive laundry powder detergent compositions can also optionally contain water-soluble ethoxylated amines having anti-redeposition properties. The inventive laundry powder detergent compositions which contain anti-redeposition agents typically contain from 0.01 to 10 wt.-% of the water-soluble ethoxylated amines.

The most preferred anti-redeposition agent is ethoxylated tetraethylenepentamine. Another group of preferred clay soil removal/anti-redeposition agents are cationic compounds. Other clay soil removal/anti-redeposition agents which can be used include ethoxylated amine polymers, zwitterionic polymers and amine oxides. Other anti-redeposition agents known in the art can also be utilized in the compositions herein. Another type of preferred anti-redeposition agents include the carboxy methyl cellulose (CMC) materials. These materials are well known in the art.

### Polymeric Dispersing Agents

Polymeric dispersing agents can advantageously be utilized at levels from 0.1 to 7 wt.-% in the inventive laundry powder detergent compositions herein, especially in the presence of zeolite and/or layered silicate builders. Suitable polymeric dispersing agents include polymeric polycarboxylates and polyethylene glycols, although others known in the art can also be used. It is believed, though it is not intended to be limited by theory, that polymeric dispersing agents enhance overall detergent builder performance, when used in combination with other builders (including lower molecular weight polycarboxylates) by crystal growth inhibition, particulate soil release peptization, and anti-redeposition.

Polymeric polycarboxylate materials can be prepared by polymerizing or copolymerizing suitable unsaturated monomers, preferably in their acid form. Unsaturated monomeric acids that can be polymerized to form suitable polymeric polycarboxylates include acrylic acid, maleic acid (or maleic anhydride), fumaric acid, itaconic acid, aconitic acid, mesaconic acid, citraconic acid and methylenemalonic acid. The presence in the polymeric polycarboxylates herein of monomeric segments, containing no carboxylate radicals such as vinylmethyl ether, styrene, ethylene, etc. is suitable provided that such segments do not constitute more than 40 wt.-%.

Particularly suitable polymeric polycarboxylates can be derived from acrylic acid. Such acrylic acid-based polymers which are useful herein are the water-soluble salts of polymerized acrylic acid. The average molecular weight of such polymers in the acid form preferably ranges from 2,000 to 10,000, more preferably from 4,000 to 7,000 and even more preferably from 4,000 to 5,000. Water-soluble salts of such acrylic acid polymers can include, for example, the alkali metal, NH₄⁺ and substituted ammonium salts. Soluble polymers of this type are known materials. Use of polyacrylates of this type in detergent compositions is known in the art.

Acrylic/maleic-based copolymers may also be used as a preferred component of polymeric dispersing agents. Such materials include the water-soluble salts of copolymers of acrylic acid and maleic acid. The average molecular weight of such copolymers in the acid form preferably ranges from 2,000 to 100,000, more preferably from 5,000 to 75,000 and even more preferably from 7,000 to 65,000. The ratio of acrylate to maleate segments in such copolymers will generally range from 30:1 to 1:1, preferably from 10:1 to 2:1. Water-soluble salts of such acrylic acid/maleic acid copolymers can include, for example, the alkali metal, NH₄⁺ and substituted ammonium salts. Soluble acrylate/maleate copolymers of this type are known materials.

Another polymeric dispersing agent which can be included is polyethylene glycol (PEG). PEG can exhibit dispersing agent performance as well as act as polymeric anti-redeposition agent. Typical molecular weight ranges for these purposes range from 500 to 100,000, preferably from 1,000 to 50,000 and more preferably from 1,500 to 10,000.

Polyaspartate and polyglutamate polymeric dispersing agents may also be used, especially in conjunction with zeolite builders.

### Brighteners

Any optical brighteners or other brightening or whitening agents known in the art can be incorporated at levels typically from 0.05 to 1.2 wt.-% into the inventive laundry powder detergent compositions herein. Commercial optical brighteners which may be useful in the present invention can be classified into subgroups which include, but are not necessarily limited to, derivatives of stilbene, pyrazoline, coumarin, carboxylic acid, methinecyanines, dibenzothiphene-5,5-dioxide, azoles, 5- and 6-membered-ring heterocycles and other miscellaneous agents. Examples of such brighteners are disclosed in “The Production and Application of Fluorescent Brightening Agents”, M. Zahradnik, Published by John Wiley & Sons, New York (1982).

Specific examples of optical brighteners include the PHORWHITE (tradename) series. Other brighteners disclosed in this reference include: Tinopal (tradename) UNPA, Tinopal (tradename) CBS and Tinopal (tradename) 5BM; available from Ciba-Geigy, Arctic White (tradename) CC and Artie White (tradename) CWO, available from Hilton-Davis, located in Italy; the 2-(4-styryl-phenyl)-2H-naphthol [1,2-d]triazoles, 4,4′-bis-(1,2,3-triazol-2-yl)-stilbenes, 4,4′-bis(styryl)bisphenyls and the aminocoumarins. Specific examples of these brighteners include 4-methyl-7-diethyl-amino coumarin, 1,2-bis(-benzimidazol-2-yl)-ethylene; 1,3-diphenylphrazolines; 2,5-bis(benzoxazol-2-yl)thiophene; 2-styrylnaphth-[1,2-d]oxazole and 2(stilbene-4-yl)-2H-naphtho-[1,2-d]triazole.

### Suds Suppressors

Compounds for reducing or suppressing the formation of suds can be incorporated into the inventive laundry powder detergent compositions. Suds suppression can be important under conditions such as those found in European-style front loading automatic washing machines, or in concentrated detergency processes, or when the inventive laundry powder detergent compositions herein optionally include a relatively high sudsing adjunct surfactant.

A wide variety of materials may be used as suds suppressors, and suds suppressors are well known to those skilled in the art. See, for example, Kirk Othmer Encyclopedia of Chemical Technology, Third Edition, Volume 7, pages 430-447 (John Wiley & Sons, Inc., 1979). One category of suds suppressor of interest encompasses monocarboxylic fatty acids and soluble salts therein. The monocarboxylic fatty acids and salts thereof used as suds suppressor typically have hydrocarbyl chains of 10 to 24, preferably 12 to 18, carbon atoms. Suitable salts include the alkali metal salts such as Na⁺, K⁺, and Li⁺ salts, and NH₄⁺ and alkanolammonium salts.

The inventive laundry powder detergent compositions herein may also contain non-surfactant suds suppressors. These include, for example: high molecular weight hydrocarbons such as paraffin, fatty acid esters (e.g., fatty acid triglycerides), fatty acid esters of monovalent alcohols, aliphatic ketones having 18 to 40 carbon atoms (e.g. stearone), etc. Other suds inhibitors include N-alkylated amino triazines such as tri- to hexa-alkylmelamines or di- to tetra-alkyldiamine chlortriazines formed as products of cyanuric chloride with two or three moles of a primary or secondary amine having 1 to 24 carbon atoms, propylene oxide, and monostearyl phosphates such as monostearyl alcohol phosphate ester and monostearyl di-alkali metal (e.g. K⁺, Na⁺, and Li⁺) phosphates and phosphate esters. The hydrocarbons such as paraffin and haloparaffin can be utilized in liquid form. The liquid hydrocarbons will be liquid at room temperature and atmospheric pressure and will have a pour point in the range from −40 to 5° C., and a minimum boiling point not less than 110° C. (atmospheric pressure). It is also known to utilize waxy hydrocarbons, preferably having a melting point below 100° C. The hydrocarbons constitute a preferred category of suds suppressor for the inventive laundry powder detergent compositions. The hydrocarbons in hydrocarbon suds suppressors include aliphatic, alicyclic, aromatic, and heterocyclic saturated or unsaturated hydrocarbons having from 12 to 70 carbon atoms. The term “paraffin,” as used in this suds suppressor discussion, is intended to include mixtures of true paraffins and cyclic hydrocarbons.

Another preferred category of non-surfactant suds suppressors comprises silicone suds suppressors. This category includes the use of polyorganosiloxane oils, such as polydimethylsiloxane, dispersions or emulsions of polyorganosiloxane oils or resins, and combinations of polyorganosiloxane with silica particles wherein the polyorganosiloxane is chemisorbed of fused onto the silica.

Other silicone suds suppressors known in the art relate to compositions and processes for defoaming aqueous solutions by incorporating therein small amounts of polydimethylsiloxane fluids.

An exemplary silicone-based suds suppressor for use herein is suds suppressing amount of a suds controlling agent consisting essentially of:
(i) polydimethylsiloxane fluid having a viscosity of from 20 cs. to 1500 cs. at 25° C.;
(ii) from 5 to 50 wt.-% of (i) of siloxane resin composed of (CH₃)₃SiO_{1/2} units of SiO₂ units in a ratio of from (CH₃)₃SiO_{1/2} units and to SiO₂ units of from 0.6:1 to 1.2:1; and
(iii) from 1 to 20 wt.-% of (i) of a solid silica gel.

In the preferred silicone suds suppressor used herein, the solvent for a continuous phase is made up of certain polyethylene glycols or polyethylene-polypropylene glycol copolymers or mixtures thereof and not polypropylene glycol. The primary silicone suds suppressor is branched/crosslinked and not linear.

To illustrate this point further, the inventive laundry powder detergent compositions with controlled suds will optionally comprise from 0.001 to 1 wt.-%, preferably from 0.01 to 0.7 wt.-% and more preferably from 0.05 to 0.5 wt.-% of said silicone suds suppressor, which comprises (1) a nonaqueous emulsion of a primary antifoam agent which is a mixture of (a) a polyorganosiloxane, (b) a resinous siloxane or a silicone resin-producing silicone compound, (c) a finely divided filler material, and (d) a catalyst to promote the reaction of mixture components (a), (b) and (c), to form silanolates; (2) at least one nonionic silicone surfactant; and (3) polyethylene glycol or a copolymer of polyethylene-polypropylene glycol having a solubility in water at room temperature of more than about 2 wt.-% and without polypropylene glycol.

The silicone suds suppressor herein preferably comprises polyethylene glycol and a copolymer of polyethylene glycol/polypropylene glycol, all having an average molecular weight of less than 1,000 and preferably between 100 and 800. The polyethylene glycol and polyethylene/polypropylene copolymers herein have a solubility in water at room temperature of more than 2 wt.-% and preferably more than 5 wt.-%.

The preferred solvent herein is polyethylene glycol having an average molecular weight of less than 1,000, preferably between 100 and 800 and more preferably between 200 and 400, and a copolymer of polyethylene glycol/polypropylene glycol, preferably PPG 200/PEG 300. Preferred is a weight ratio of between 1:1 and 1:10, preferably between 1:3 and 1:6, of polyethylene glycol:copolymer of polyethylene-polypropylene glycol.

The preferred silicone suds suppressors used herein to not contain polypropylene glycol, particularly of 4,000 molecular weight. They also preferably do not contain block copolymers of ethylene oxide and propylene oxide, like PLURONIC (tradename) L101.

Other suds suppressors useful herein comprise the secondary alcohols (e.g., 2-alkyl alkanols) and mixtures of such alcohols with silicone oils. The secondary alcohols include alkyl alcohols having 6 to 16 carbon atoms. A preferred alcohol is 2-butyl octanol, which is available from Condea under the trademark ISOFOL 12. Mixtures of secondary alcohols are available under the trademark ISALCHEM 123 from Enichem. Mixed suds suppressors typically comprise mixtures of alcohol-silicone at a weight ratio of 1:5 to 5:1.

For any laundry powder detergent composition to be used in automatic washing machines, suds should not form to the extent that they overflow the washing machine. Suds suppressors, when utilized, are preferably present in a “suds suppressing amount.” By “suds suppressing amount” is meant that the formulator of the inventive laundry powder detergent compositions can select an amount of this suds controlling agent that will sufficiently control the suds to result in a low-sudsing laundry detergent for use in automatic washing machines.

The inventive laundry powder detergent compositions herein will generally comprise from 0 to 5 wt.-% of suds suppressor. When utilized as suds suppressors, monocarboxylic fatty acids, and salts therein, will be present typically in amounts up to 5 wt.-%, preferably from 0.5 to 3 wt.-%, of the inventive laundry powder detergent compositions. Silicone suds suppressors are typically utilized in amounts up to 2 wt.-%, of the inventive laundry powder detergent compositions, although higher amounts may be used. This upper limit is practical in nature, due primarily to concern with keeping costs minimized and effectiveness of lower amounts for effectively controlling sudsing. From 0.01 to 1 wt.-%, preferably 0.25 to 0.5 wt.-% of silicone suds suppressor is used. As used herein, these weight percentage values include any silica that may be utilized in combination with polyorganosiloxane, as well as any adjunct materials that may be utilized.

Monostearyl phosphate suds suppressors are generally utilized in amounts ranging from 0.1 to 2 wt.-%, of a laundry powder detergent composition. Hydrocarbon suds suppressors are typically utilized in amounts ranging from 0.01 to 5 wt.-%, although higher levels can be used. The alcohol suds suppressors are typically used from 0.2 to 3 wt.-% of a laundry powder detergent composition.

### Fabric Softeners

Various through-the-wash fabric softeners, especially impalpable smectite clays, as well as other softener clays known in the art, can optionally be used typically at levels of from 0.5 to 10 wt.-% of the inventive laundry powder detergent compositions to provide fabric softener benefits concurrently with fabric cleaning. Clay softeners can be used in combination with amine and cationic softeners. Mixtures of cellulase enzymes (e.g. CAREZYME (tradename), Novo) and clays are also useful as high-performance fabric softeners. Various cationic materials can be added to enhance static control.

### Dye Transfer Inhibiting Agents

The inventive laundry powder detergent composition may also include one or more materials effective for inhibiting the transfer of dyes from one fabric to another during the cleaning process. Generally, such dye transfer inhibiting agents include polyvinyl pyrrolidone polymers, polyamine N-oxide polymers, copolymers of N-vinylpyrrolidone and N-vinylimidazole, manganese phthalocyanine, peroxidases and mixtures thereof. If used, these agents typically comprise from 0.01 to 10 wt.-%, preferably from 0.01 to 5 wt.-% and more preferably from 0.05 to 2 wt.-%, of the inventive laundry powder detergent compositions.

More specifically, the polyamine N-oxide polymers preferred for use herein contain units having the following structural formula (VI):

R6-Aₓ-P (VI)

wherein
P is a polymerizable unit to which an N—O group can be attached, or the N—O group can form part of the polymerizable unit or the N—O group can be attached to both units,
A is one of the following structures: —NC(O)—, —C(O)O—, —S—, —O—, —N═,
x is 0 or 1,
R is aliphatics, ethoxylated aliphatics, aromatics, heterocyclic or alicyclic groups or any combination thereof to which the nitrogen of the N—O group can be attached, or the N—O group is part of these groups. Preferred polyamine N-oxides are those wherein R6 is a heterocyclic group such as pyridine, pyrrole, imidazole, pyrrolidine, piperidine and derivatives thereof.

The variable “x” in the one or more compounds of the formula (VI) preferably represents molar averages, meaning that the laundry powder detergents of the invention may comprise a plurality of compounds of the formula (VI) having different degrees of group A.

Any polymer backbone can be used if the amine oxide polymer formed is water-soluble and has dye transfer inhibiting properties. Examples of suitable polymeric backbones are polyvinyls, polyalkylenes, polyesters, polyethers, polyimide, polyim ides, polyacrylates and mixtures thereof. These polymers include random or block copolymers where one monomer type is an amine N-oxide and the other monomer type is an N-oxide. The amine N-oxide polymers typically have a ratio of amine to the amine N-oxide of 10:1 to 1:1,000,000. However, the number of amine oxide groups present in the polyamine oxide polymer can be varied by appropriate copolymerization or by an appropriate degree of N-oxidation. The polyamine oxides can be obtained in almost any degree of polymerization. Typically, the average molecular weight is within the range from 500 to 1,000,000, preferably from 1,000 to 500,000 and more preferably from 5,000 to 100,000. This preferred class of materials can be referred to as “PVNO”.

The preferred polyamine N-oxide useful in the inventive laundry powder detergent compositions herein is poly(4-vinylpyridine-N-oxide) which as an average molecular weight of about 50,000 and an amine to amine N-oxide ratio of about 1:4.

Copolymers of N-vinylpyrrolidone and N-vinylimidazole polymers (referred to as a class as “PVPVI”) are also preferred for use herein. Preferably the PVPVI has an average molecular weight range from 5,000 to 1,000,000, preferably from 5,000 to 200,000 and more preferably from 10,000 to 20,000. The PVPVI copolymers typically have a molar ratio of N-vinylimidazole to N-vinylpyrrolidone from 1:1 to 0.2:1, preferably from 0.8:1 to 0.3:1 and more preferably from 0.6:1 to 0.4:1. These copolymers can be either linear or branched.

The inventive laundry powder detergent compositions also may employ a polyvinylpyrrolidone (“PVP”) having an average molecular weight of from 5,000 to 400,000, preferably from 5,000 to 200,000 and more preferably from 5,000 to 50,000. PVP's are known to persons skilled in the detergent field. Compositions containing PVP can also contain polyethylene glycol (“PEG”) having an average molecular weight from 500 to 100,000, preferably from 1,000 to 10,000. The ratio of PEG to PVP on a ppm basis delivered in wash solutions is from 2:1 to 50:1, preferably from 3:1 to 10:1.

The inventive laundry powder detergent compositions herein may also optionally contain from 0.005 to 5 wt.-% of certain types of hydrophilic optical brighteners which also provide a dye transfer inhibition action. If used, the compositions herein will preferably comprise from 0.01 to 1 wt.-% of such optical brighteners.

The hydrophilic optical brighteners useful in the present invention are those having the structural formula (VII):

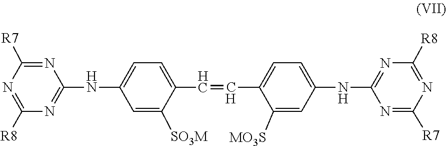

wherein
R7 is selected from anilino, N-2-bis-hydroxyethyl and NH-2-hydroxyethyl,
R8 is selected from N-2-bis-hydrox-yethyl, N-2-hydroxyethyi-N-methylamino, morphilino, chloro and amino, and
M is a salt-forming cation such as Na⁺ or K⁺.

When in the above formula, R7 is anilino, R8 is N-2-bis-hydroxyethyl and M is a cation such as Na⁺, the brightener is 4,4′-bis[(4-anilino-6-(N-2-bis-hydroxyethyl)-s-triazine-2-yl)amino]-2,2′-stilbenedisulfonic acid and disodium salt. This particular brightener species is commercially marketed under the tradename Tinopai-UNPA-GX by Ciba-Geigy Corporation.

When in the above formula, R7 is anilino, R8 is N-2-hydroxyethyi-N-2-methylamino and M is a cation such as Nat, the brightener is 4,4′-bis[(4-anilino-6-(N-2-hydroxyethyi-N-methylamino)-s-triazine-2-yl)amino]2,2′-stilbenedi-sulfonic acid disodium salt. This brightener species is commercially marketed under the tradename Tinopa 5BM-GX by Ciba-Geigy Corporation.

When in the above formula, R7 is anilino, R8 is morphilino and M is a cation such as Na⁺, the brightener is 4,4′-bis[(4-anilino-6-morphilino-s-triazine-2-yl)amino]2,2′-stilbenedisulfonic acid, sodium salt. This particular brightener species is commercially marketed under the tradename Tinopal AMS-GX by Ciba Geigy Corporation.

The specific optical brightener species selected for use in the present invention provide especially effective dye transfer inhibition performance benefits when used in combination with the selected polymeric dye transfer inhibiting agents hereinbefore described. The combination of such selected polymeric material (e.g., PVNO and/or PVPVI) with such selected optical brighteners (e.g., Tinopal (tradename) UNPA-GX, Tinopal 5BM-GX and/or Tinopal (trade-name) AMS-GX) provides significantly better dye transfer inhibition in aqueous wash solutions than does either of these two components when used alone. Without being bound by theory, it is believed that such brighteners work this way because they have high affinity for fabrics in the wash solution and therefore deposit relatively quick on these fabrics. The extent to which brighteners deposit on fabrics in the wash solution can be defined by a parameter called the “exhaustion coefficient”. The exhaustion coefficient is in general as the ratio of a) the brightener material deposited on fabric to b) the initial brightener concentration in the wash liquor. Brighteners with relatively high exhaustion coefficients are the most suitable for inhibiting dye transfer in the context of the present invention.

Other, conventional optical brightener types of compounds can optionally be used in the inventive laundry powder detergent compositions to provide conventional fabric “brightness” benefits, rather than a true dye transfer inhibiting effect.

The inventive laundry powder detergent compositions can optionally contain further additives such as perfumes, colorants or dyes.

In one preferred embodiment of the invention the inventive laundry powder detergent compositions comprise from 0 to 10 wt.-% and preferably from 1 to 10 wt.-% of the one or more further additives of component Z6).

Preferably, the inventive laundry powder detergent compositions comprise
Z1) from 0.5 to 50 wt.-%, preferably from 1 to 25 wt.-% and more preferably from 1.5 to 17 wt.-% of component Z1),
Z2) from 1 to 50 wt.-%, preferably from 5 to 30 wt.-% of component Z2),
Z3) from 0 to 30 wt.-%, preferably from 1 to 30 wt.-%, and more preferably from 5 to 25 wt.-% of component Z3),
Z4) from 1 to 90 wt.-%, preferably from 10 to 80 wt.-%, more preferably from 15 to 50 wt.-% of component Z4),
Z5) from 0 to 30 wt.-%, preferably from 1 to 30 wt.-%, more preferably from 5 to 20 wt.-% of component Z5),
Z6) from 0 to 10 wt.-% and preferably from 1 to 10 wt.-% of component Z6)
   based in each case on the total weight of the laundry powder detergent composition.

A further subject matter of the present invention is the use of the inventive laundry powder detergent compositions for cleaning of textiles.

The cleaning of textiles using the inventive laundry powder detergent compositions may be carried out in automatic washing machines or as manual cleaning.

The one or more surfactants of component Z1) of the inventive laundry powder detergent compositions are loaded on the magnesium carbonate carrier and thereby the thermal degradation of the surfactants during the preparation of the inventive laundry powder detergent compositions can be reduced. A further subject matter of the present invention therefore is the use of one or more surfactants on magnesium carbonate carrier of component Z1) of the inventive laundry powder detergent compositions for reducing the thermal degradation of the surfactants during the preparation of the inventive laundry powder detergent compositions.

The one or more surfactants on magnesium carbonate carrier of component Z1) of the inventive laundry powder detergent compositions may advantageously be used for the preparation of the inventive laundry powder detergent compositions. A further subject matter of the present invention therefore is the use of one or more surfactants on magnesium carbonate carrier of component Z1) of the inventive laundry powder detergent compositions for the preparation of the inventive laundry powder detergent compositions.

The respective preparation of the inventive laundry powder detergent compositions may preferably be carried out as follows: Component Z1) is not spray-dried but is prepared separately from the other ingredients of the laundry powder detergent composition, preferably at a temperature of 100° C. or below 100° C., more preferably at temperatures from 10 to 80° C., even more preferably at temperatures from 20 to 75° C., preferably by physically mixing the one or more surfactants of component Z1), either (i) in a molten state, wherein the melting is performed at a temperature of 100° C. or below 100° C., or (ii) dissolved in a solvent, preferably selected from the group consisting of water, alkanes, esters, ethers and alcohols and more preferably water, and the magnesium carbonate carrier, and in case (ii) the solvent is removed afterwards, preferably under reduced pressure at a temperature of 100° C. or below 100° C., more preferably at temperatures from 10 to 80° C., and then component Z1) is physically mixed with the other ingredients of the laundry powder detergent composition, preferably at temperatures from 20 to 40° C.

The dissolving of the one or more surfactants of component Z1) to be used in case (ii) of the inventive preparation of the laundry powder detergent compositions of the invention preferably takes place at temperatures from 20 to 60° C. and more preferably at temperatures from 20 to 40° C.

The use of these mild processing conditions leads to reducing degradation of surfactants that are used in the preparation of the laundry powder detergent compositions.

The preferred embodiments specified above for the laundry powder detergent compositions of the invention are also valid correspondingly for the inventive use of the laundry powder detergent compositions of the invention for cleaning of textiles, for the inventive use of the one or more surfactants on magnesium carbonate carrier of component Z1) of the laundry powder detergent compositions of the invention for reducing the thermal degradation of the surfactants during the preparation of the laundry powder detergent compositions of the invention and for the preparation of the laundry powder detergent compositions of the invention, and also for the inventive preparation of the laundry powder detergent compositions of the invention.

1. A laundry powder detergent composition comprising
Z1) one or more surfactants on magnesium carbonate carrier and
Z2) one or more anionic surfactants which are not present on a carrier.

2. The laundry powder detergent composition according to claim 1, wherein the one or more surfactants on magnesium carbonate carrier of component Z1) are selected from the group consisting of nonionic and anionic surfactants.

3. The laundry powder detergent composition according to claim 1, wherein the one or more surfactants on magnesium carbonate carrier of component Z1) are selected from the group consisting of N-hydrocarbon-substituted N-acyl-glucamines and alkyl or alkenyl ether carboxylic acids or their salts.

4. The laundry powder detergent composition according to claim 3, characterized in that the N-hydrocarbon-substituted N-acyl-glucamines on magnesium carbonate carrier are selected from the group comprising the N-hydrocarbon-substituted N-acyl-glucamines according to formula (I) 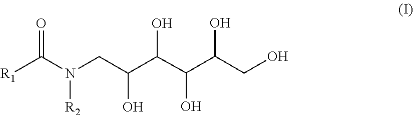
wherein
R1 is a linear or branched alkyl group having 7 to 21 carbon atoms,
R2 is a linear or branched, alkyl group having 1 to 6 carbon atoms.

5. The laundry powder detergent composition according to claim 4, characterized in that in formula (I) the group R1 is a linear saturated alkyl group having 11 to 13 carbon atoms and R2 is a methyl group.

6. The laundry powder detergent composition according to claim 4, characterized in that in formula (I) the group R1CO derives from coconut oil and R2 is a methyl group.

7. The laundry powder detergent composition according to claim 4, characterized in that in formula (I) the group R1CO derives from sunflower oil and R2 is a methyl group.

8. The laundry powder detergent composition according to claim 3, characterized in that the alkyl or alkenyl ether carboxylic acids or their salts are selected from the group consisting of compounds according to formula (II) 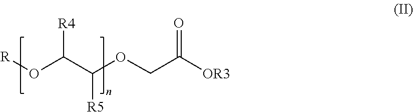
wherein
R is a linear or branched, alkyl group having 6 to 22 carbon atoms,
R4 and R5 are either both hydrogen, or R4 is hydrogen and R5 is methyl, or R4 is methyl and R5 is hydrogen,
R3 is hydrogen or a cation,
n is a number from 1 to 30.

9. The laundry powder detergent composition according to claim 8, characterized in that in formula (II) the group R is oleyl, R4 and R5 are hydrogen and n is from 5 to 15.

10. The laundry powder detergent composition according to claim 8, characterized in that in formula (II) the group R is stearyl, R4 and R5 are hydrogen and n is from 10 to 25.

11. The laundry powder detergent composition according to claim 1, characterized in that component Z1) comprises the one or more surfactants in an amount ranging from 10 to 300 wt.-%, based on the total weight of the magnesium carbonate carrier.

12. The laundry powder detergent composition according to claim 1, characterized in that it comprises the one or more surfactants on magnesium carbonate carrier of component Z1) in an amount from 0.5 to 50 wt.-%, based in each case on the total weight of laundry powder detergent composition.

13. The laundry powder detergent composition according to claim 1, characterized in that the one or more anionic surfactants which are not present on a carrier Z2) are selected from the group consisting of sulfate surfactants and sulfonate surfactants.

14. The laundry powder detergent composition according to claim 13, characterized in that the one or more sulfate surfactants which are not present on a carrier Z2) are selected from the group consisting of linear or branched, saturated alkyl sulfates, linear or branched unsaturated alkenyl sulfates having one or more double bonds, linear or branched, saturated alkyl ether sulfates, and linear or branched unsaturated alkenyl ether sulfates having one or more double bonds.

15. The laundry powder detergent composition according to claim 13, characterized in that the one or more sulfonate surfactants which are not present on a carrier Z2) are selected from the group consisting of linear or branched, alkylbenzene sulfonates wherein the alkyl group is saturated, linear or branched alkyl sulfonates wherein the alkyl group is saturated, linear or branched alkyl xylene sulfonates wherein the alkyl group is saturated and fatty acid ester sulfonates.

16. The laundry powder detergent composition according to claim 1, characterized in that it comprises the one or more anionic surfactants which are not present on a carrier Z2) in an amount from 1 to 50 wt. %, based in each case on the total weight of the laundry powder detergent composition.

17. The laundry powder detergent composition according to claim 1, characterized in that it comprises not only the one or more surfactants on magnesium carbonate carrier Z1) and the one or more anionic surfactants which are not present on a carrier Z2), but also one or more further substances selected from the components Z3), Z4), Z5), and/or Z6)
Z3) one or more fatty alcohol alkoxylates, as component Z3),
Z4) one or more detergent builders as component Z4),
Z5) one or more bleaching compounds as component Z5),
Z6) one or more further additives as component Z6),
and the pH of the laundry powder detergent composition at 20° C. is from 7 to 14, measured as a 10 wt.-% solution of the laundry powder detergent composition in water.

18. The laundry powder detergent composition according to claim 17, characterized in that it comprises
Z1) from 0.5 to 50 wt. %, of component Z1),
Z2) from 1 to 50 wt.-%, of component Z2),
Z3) from 0 to 30 wt.-%, of component Z3),
Z4) from 1 to 90 wt.-%, of component Z4),
Z5) from 0 to 30 wt.-%, of component Z5),
Z6) from 0 to 10 wt.-% of component Z6)
based in each case on the total weight of the laundry powder detergent composition.

19. A method of cleaning a textile comprising the step of contacting the textile with a laundry powder detergent composition according to claim 1.

20. The method according to claim 19, characterized in that the cleaning of textiles is carried out in an automatic washing machine or as manual cleaning.

21. The method according to claim 19, wherein the laundry powder detergent composition comprises one or more surfactants on magnesium carbonate carrier Z1) for reducing the thermal degradation of the surfactants during the preparation of the laundry powder detergent composition.

22. The method according to claim 19, wherein the laundry powder detergent composition comprises one or more surfactants on magnesium carbonate carrier Z1) for the preparation of a laundry powder detergent composition.

23. A method of preparing of a laundry powder detergent composition comprising
Z1) one or more surfactants on magnesium carbonate carrier
and
Z2) one or more anionic surfactants which are not present on a carrier
comprising the steps of not spray-drying component Z1) and preparing it separately from the other ingredients of the laundry powder detergent composition, physically mixing the one or more surfactants of component Z1), either (i) in a molten state, wherein the melting is performed at a temperature of 100° C. or below 100° C., or (ii) dissolved in a solvent, and the magnesium carbonate carrier, and in case (ii) the solvent is removed afterwards, and then component Z1) is physically mixed with the other ingredients of the laundry powder detergent composition.
